(19) United States
(12) Patent Application Publication
(10) Pub. No.: US 2002/0147778 A1
(43) Pub. Date: Oct. 10, 2002

(54) System and method for customized e-mail services

(75) Inventor: Rabindranath Dutta, Austin, TX (US)

Correspondence Address: Paul D. Heydon, Patent Attorney, 6102 Broadway, Suite B2, San Antonio, TX, 78209, US

(73) Assignee: International Business Machines Corporation, Armonk, NY

(21) Appl. No.: 09/826,708

(22) Filed: Apr. 5, 2001

(51) Int. Cl. G06F 15/16

(52) U.S. Cl. 709/206

(57) ABSTRACT

The present invention is a system and method for customized electronic mail (e-mail) services. One set of the invention's features involve receiving input from the sender specifying the recipients of an e-mail message, and for each of the recipients, receiving input from the sender to create a tag indicating the importance of the e-mail message. The tags may vary from recipient to recipient. A second set of features involve receiving input from a sender specifying a recipient of an e-mail message, and then communicating to the sender the recipient's preferences concerning e-mail, before the e-mail message is transmitted to the recipient. This allows and encourages the sender to transmit a message that conforms to the recipient's preferences. One aspect of the present invention is a method for customized e-mail services. Another aspect of the present invention is a system for executing the method of the present invention. A third aspect of the present invention is as a set of instructions on a computer-usable medium, or resident in a computer system, for executing the method of the present invention.

### FIELD OF THE INVENTION

The present invention relates generally to electronic mail, and more particularly to methods and systems for customized e-mail services.

### BACKGROUND OF THE INVENTION

Many e-mail users experience problems with a high volume of e-mail, requiring that much of recipients'time is spent in handling e-mail. An e-mail user typically has many messages waiting, and competing for the user's attention, in the user's mailbox in the e-mail system. An e-mail user typically looks at the contents of the mailbox, or “inbox,” and based on the scant information displayed there, decides which messages to open and read first. Information displayed regarding contents of the mailbox might not be very helpful. E-mail systems in use today make it easy for senders to send an e-mail message to a large number of recipients, and perhaps tag it as “urgent,” although this may not be an accurate tag for many of the recipients.

E-mail systems in use today entail a second set of problems, regarding lengthy e-mail messages or e-mail messages with large files attached. Such messages may pose problems for a recipient who is not using a high-speed Internet connection, or a recipient who handles e-mail via hand-held devices, like cell phones, two-way pagers, or hand-held computers. Lengthy e-mail messages, or e-mail messages with large files attached, may be difficult to handle with hand-held devices' small screens and limited memory. Considering direct access to e-mail via wireless devices, lengthy e-mail messages or large files pose additional problems due to wireless devices' low data-transmission rates (low bandwidth). Thus, some recipients may strongly prefer brief e-mail messages, without attachments. However, senders may not know of this preference.

Thus there is a need for systems and methods that allow senders to adapt the use of e-mail message tags to each recipient, make recipients' preferences known to senders, and make those preferences easy for senders to implement.

### SUMMARY OF THE INVENTION

One set of the invention's features involve receiving input from the sender specifying the recipients of an e-mail message, and for each of the recipients, receiving input from the sender to create a tag indicating the importance of the e-mail message. The tags may vary from recipient to recipient. Then when a recipient looks at the contents of the mailbox, information will be found that is accurate for that particular recipient, and the recipient can better decide which messages to open and read first.

A second set of features involve receiving input from a sender specifying a recipient of an e-mail message, and then communicating to the sender the recipient's preferences concerning e-mail, before the e-mail message is transmitted to the recipient. This allows and encourages the sender to transmit a message that conforms to the recipient's preferences. For example, these communicated preferences might concern the size of e-mail messages sent to the recipient. As another example, the preferences might concern how to rate the importance of the e-mail message, in terms that are helpful to the recipient. Then when the recipient looks at the contents of the mailbox, helpful information will be found there, and the recipient can better decide which messages to open and read first.

### BRIEF DESCRIPTION OF THE DRAWINGS

A better understanding of the present invention can be obtained when the following detailed description is considered in conjunction with the following drawings. The use of the same reference symbols in different drawings indicates similar or identical items.

FIG. 1 is a high-level block diagram illustrating an example of a system for customized e-mail services according to the teachings of the present invention. A system like this could operate in a corporation's intranet, for example.

FIG. 2 is a high-level block diagram illustrating another example of a system for customized e-mail services according to the teachings of the present invention. A system like this could operate via the Internet, for example.

FIG. 3 is a flow chart illustrating an example of a method for providing different tags for different recipients, according to the teachings of the present invention.

FIG. 4 is a flow chart illustrating an example of a method for implementing a recipient's preferences, according to the teachings of the present invention.

FIG. 5 is a diagram illustrating two examples of tag and recipient menus, according to the teachings of the present invention.

FIG. 6 is a diagram illustrating two examples of tag menus to implement a recipient's preferences, according to the teachings of the present invention.

FIG. 7 illustrates a simplified example of a computer system capable of performing the present invention.

### DETAILED DESCRIPTION

The examples that follow involve the use of computers and a network. The present invention is not limited as to the type of computer on which it runs, and not limited as to the type of network used. The present invention uses tags to convey information about the content of e-mail messages. The use of a few predefined, general-purpose tags for e-mail messages is well-known, but the use of customized, recipient-defined tags is not.

Various implementation methods may be used for the present invention. The present invention may use any tags that are understood by both the sender's software and the recipient's software. A unique implementation scheme could be used for an organization's internal e-mail system. On the other hand, the present invention may be implemented by building upon well-known standards for e-mail. Some examples are: Simple Mail Transfer Protocol (SMTP), Multipurpose Internet Mail Extensions (MIME), and Secure Multipurpose Internet Mail Extensions (S/MIME). Regarding such standards, reference is made to the following documents: Jonathan B. Postel, Request for Comments (RFC) #821, Simple Mail Transfer Protocol, 1982; David H. Crocker, RFC #822, Standard for the Format of ARPA Internet Text Messages, 1982; and J. Palme, RFC #2076, Common Internet Message Headers, 1997. An Internet e-mail message consists of two parts: a header and a body. A header may be used to implement the present invention. A header has a collection of field-value pairs that convey information about the message. One example given in RFC 2076 is the field “Importance,” with values of “High,” “Normal,” or “Low.”

The following are definitions of terms used in the description of the present invention and in the claims: “Computer-usable medium” means any carrier wave, signal or transmission facility for communication with computers, and any kind of computer memory, such as floppy disks, hard disks, Random Access Memory (RAM), Read Only Memory (ROM), CD-ROM, flash ROM, non-volatile ROM, and non-volatile memory. “Selection signal” means any signal from a user who is making a selection, utilizing any input device, including a keyboard, speech-recognition interface, or pointing device such as a track ball, a joy stick, a touch-sensitive tablet or screen, or a mouse. “Tag” means any label, field, or value that conveys information about a message; such information may be available to a recipient before a recipient decides whether to open and read an e-mail message.

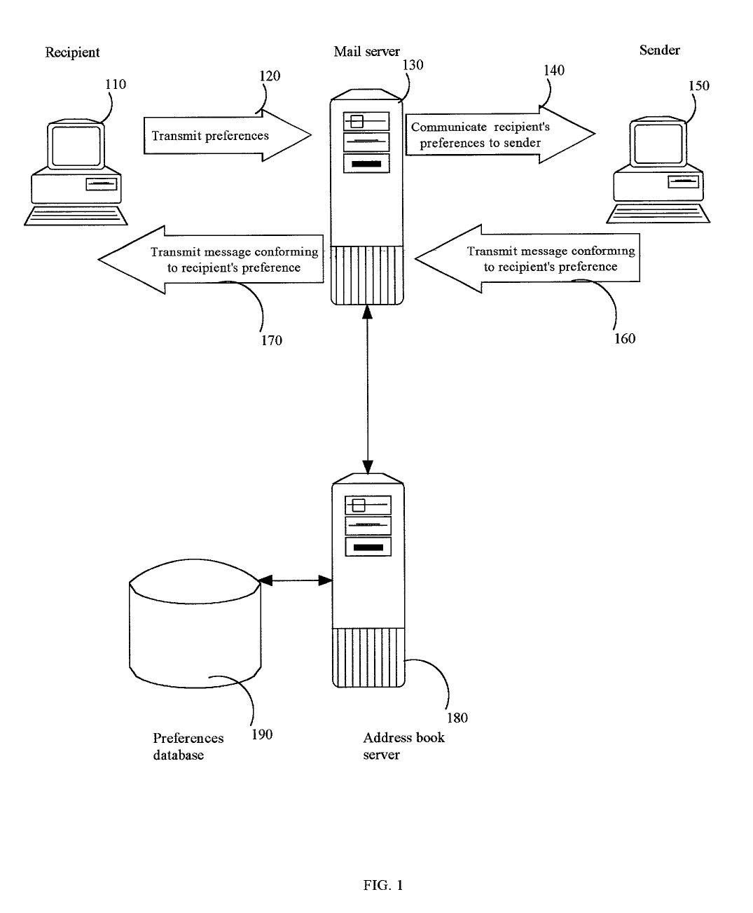

FIG. 1 is a high-level block diagram illustrating an example of a system for customized e-mail services according to the teachings of the present invention. A system like this could operate in a corporation's intranet, for example. The system receives input from a sender specifying a recipient of an e-mail message; and communicates to the sender the recipient's preferences concerning e-mail, before the e-mail message is transmitted to the recipient. At top left, a user (not shown), who will be a recipient of e-mail, uses recipient's computer 110 to transmit recipient's preferences, 120, through mail server 130, and through address book server 180, for storage in preferences database 190. Preferences database 190 identifies each e-mail recipient such as the recipient at 110, and his or her corresponding preferences concerning e-mail received by the recipient. Mail server 130 communicates with address book server 180, which communicates with preferences database 190. The system now is ready to allow customized e-mail communication from a sender, using sender's computer 150 at top right, to recipient's computer 110. The system receives input from a sender (not shown) at sender's computer 150 specifying a recipient at 110 as the recipient of an e-mail message. Through mail server 130, sender's computer 150 calls the address book function running on address book server 180. Address book server 180 retrieves from preferences database 190 the preferences of the recipient at 110. The system communicates the recipient's preferences, 140, to sender's computer 150, before the e-mail message is transmitted to the recipient's computer 110. For example, these communicated preferences might concern the size of e-mail messages sent to the recipient, or the preferences might concern how to rate the importance of the e-mail message. This allows and encourages the sender at 150 to transmit a message conforming to recipient's preferences, 160, through mail server 130, and the sender does so. Finally, mail server 130 transmits the message conforming to recipient's preferences, 170, to recipient's computer 110.

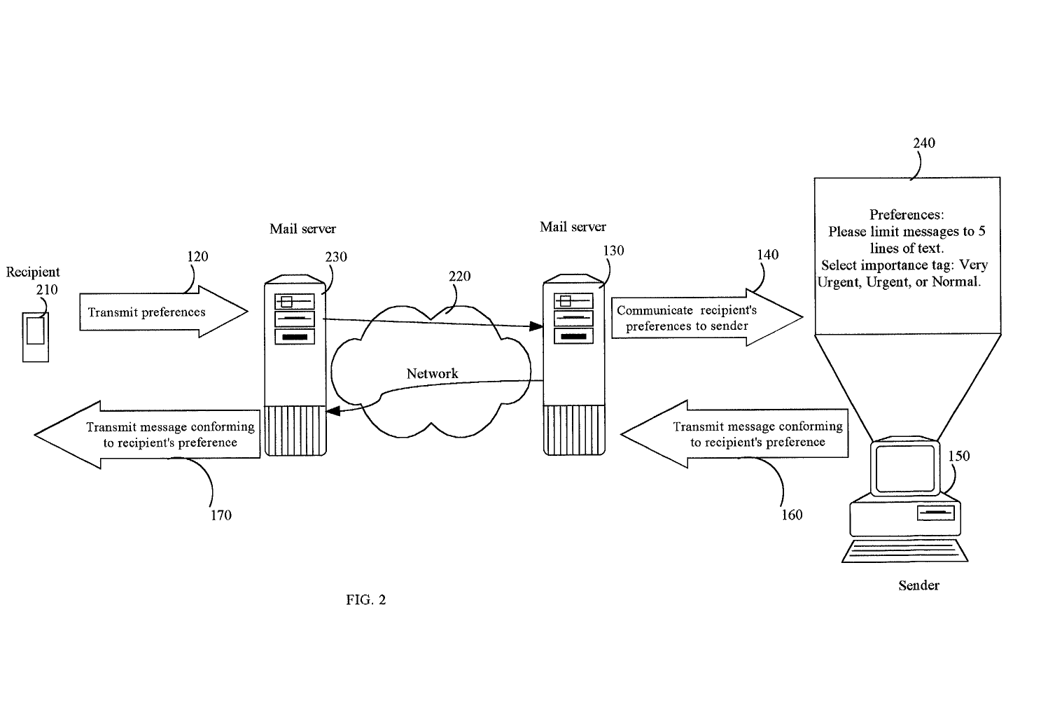

FIG. 2 is a high-level block diagram illustrating another example of a system for customized e-mail services according to the teachings of the present invention. A system like this could operate via the Internet, for example. At left, a user (not shown), who will be a recipient of e-mail, uses recipient's computer 210 to transmit recipient's preferences, 120, through recipient's mail server 230, and network 220, to sender's mail server 130. Sender's mail server 130 communicates the recipient's preferences, 140, through sender's computer 150, to a user (not shown), who will be a sender of e-mail.

This communication of recipient's preferences, 140, may be accomplished in various ways. For example, the recipient may send e-mail messages, communicating the recipient's preferences, 140, to persons from whom recipient expects to receive e-mail. Recipient's preferences then may be stored on sender's computer 150. In another example, recipient's mail server 230 could be used to automatically generate a reply message, communicating the recipient's preferences, 140, whenever a new sender sent a message to the recipient. Such automatic reply messages could be similar to the familiar vacation notification reply messages. Recipient's preferences then may be stored on sender's computer 150. Storage of these preferences on sender's computer 150 could be assisted by features included in the e-mail message, such as JavaScript code.

In another example, recipient's preferences may be stored in a preferences database connected with a server such as mail server 230. Then when sender addresses a message to recipient, an e-mail application running on sender's computer 150 may get the recipient's preferences, via network 220, and communicate the recipient's preferences, 140, through sender's computer 150, to sender.

Through any of the above-mentioned techniques, the system allows customized e-mail communication from a sender, using sender's computer 150 at right, to recipient's computer 210. The system receives input from a sender (not shown) at sender's computer 150, specifying a recipient at recipient's computer 210 as the recipient of an e-mail message. The e-mail program running on sender's computer 150 calls the address book function, which retrieves the preferences of the recipient at 210. The system communicates, 140, the recipient's preferences, and displays them, 240, to sender through sender's computer 150, before the e-mail message is transmitted to the recipient's computer 210. For example, these communicated preferences might concern the size of e-mail messages sent to the recipient, or the preferences might concern how to rate the importance of the e-mail message. This allows and encourages the sender at sender's computer 150 to transmit a message conforming to recipient's preferences, 160, through mail server 130, and network 220, and the sender does so. Finally, recipient's mail server 230 transmits the message conforming to recipient's preferences, 170, to recipient's computer 210.

In this example, recipient's computer 210 is a handheld computer, which may have limited memory, a small screen, and low data-transmission rates (low bandwidth). The system communicates the recipient's preference (“Please limit messages to 5 lines of text”), 240, that is calculated to customize e-mail messages for handling via a small, wireless device such as recipient's computer 210.

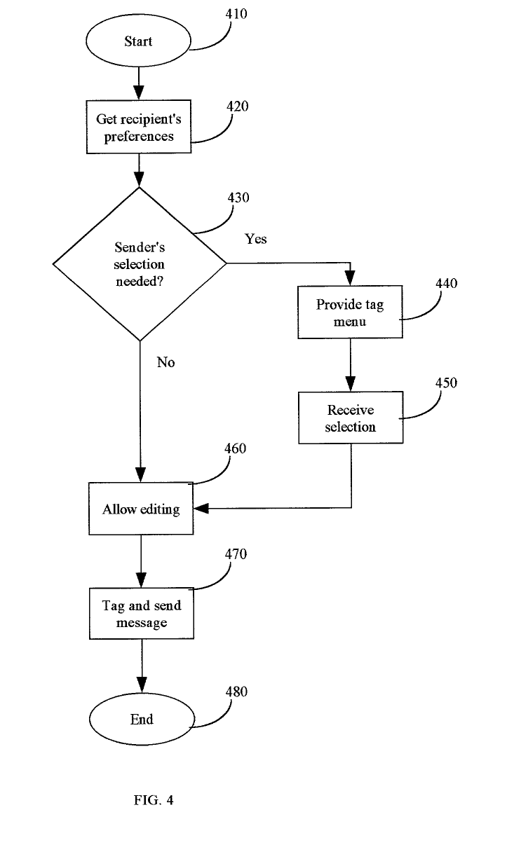

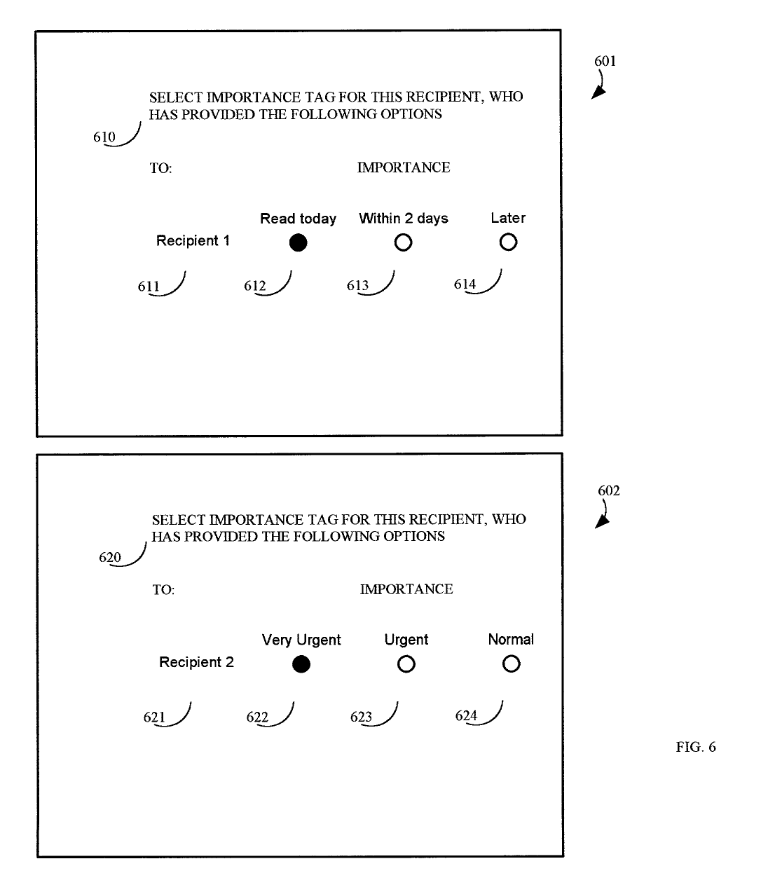

In this example, the system also communicates the recipient's preference concerning how to rate the importance of the e-mail message, in terms that are helpful to the recipient (“Select importance tag: Very Urgent, Urgent, or Normal”), 240. These preferred tags may be presented to sender in a menu, via sender's computer 150, as a way of receiving input from the sender. This feature of the invention is described in more detail below in connection with FIG. 4 and FIG. 6.

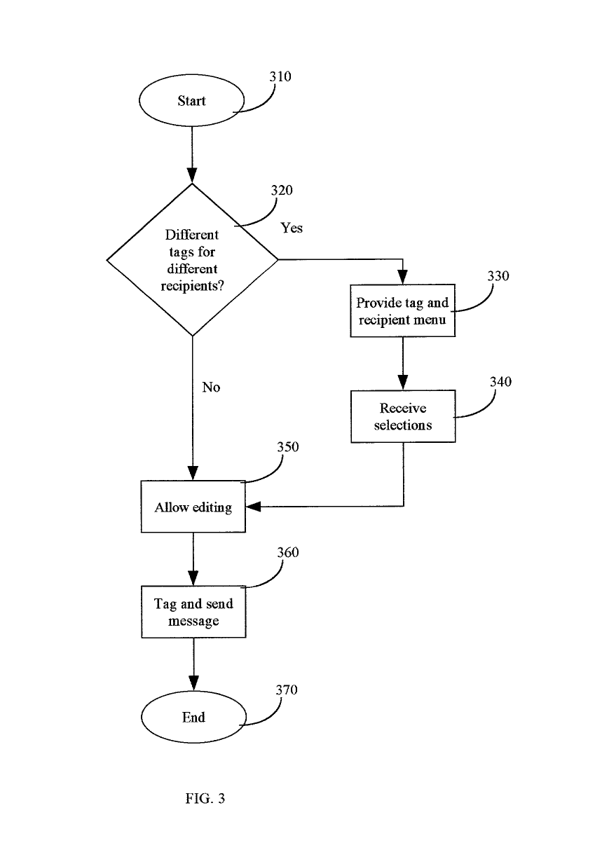

FIG. 3 is a flow chart illustrating an example of a method for sending electronic mail, while providing different tags for different recipients, according to the teachings of the present invention. The process starts at 310, which may represent a user (sender) launching an e-mail application in preparation for sending electronic mail to a plurality of recipients. At decision 320, the “No” branch may be taken, for example if the sender decides to send the message to only one recipient, so the sender would proceed directly to writing and editing the message, 350.

At decision 320, if different tags are desired for different recipients, the “Yes” branch may be taken, and the next step in this example is providing a tag and recipient menu, 330. This is a way of receiving input from the sender specifying the recipients of an e-mail message, and for each of the recipients, receiving input from the sender to create a tag indicating the importance of the e-mail message. The tags may vary from recipient to recipient. A number of features may be present here. One option is providing a plurality of tags with predefined content. Another option is automatically providing default tags, in the absence of contrary input from the sender, wherein said default tags may vary according to the status of the recipients. For example, the tag could be “Urgent” for the primary recipient, the tag could be “Normal” for recipients who will receive a copy of the message marked “cc,” and the tag could be “FYI” for recipients who will receive a copy of the message marked “bcc.” Another option is allowing the sender to compose the content of the tags, to convey certain information to certain recipients. For example, the sender may use code words, or words representing an inside joke shared with a certain recipient.

The input is received from the sender at 340. Next, writing and editing the message is allowed, 350. The message is tagged and sent at 360. For example, an e-mail application may use Transmission Control Protocol (TCP) and deliver a separate copy of the message to each recipient's mailbox. The proper tag is applied to each separate copy. With the sending accomplished, the process ends at 370.

FIG. 4 is a flow chart illustrating an example of a method for implementing a recipient's preferences, according to the teachings of the present invention. The process starts at 410, which may represent a user (sender) launching an e-mail application in preparation for sending electronic mail to a recipient, and the e-mail application receiving input from the sender specifying a recipient of an e-mail message. In response, the e-mail application gets the recipient's preferences, 420. For example, this may be implemented by maintaining a database identifying at least one e-mail recipient and his or her corresponding preferences concerning e-mail received by the recipient, and retrieving preferences from the database. At decision 430, the “No” branch may be taken, for example if the recipient's preferences involve only the length of an e-mail message, and no selection of a tag by the sender is required. In that case, the sender would proceed directly to writing and editing the message, 460.

At decision 430, if the selection of a tag by the sender is required, the “Yes” branch may be taken, and the next step in this example is providing a tag menu, 440. This is a way of communicating to the sender at least one of the recipient's preferences concerning e-mail received by the recipient, before said e-mail message is transmitted to the recipient. The recipient's preferences are provided as a set of menu entries to the sender. The recipient's preferences might involve rating the importance of the e-mail message. The sender may choose a tag from the menu. A menu entry selection signal is received from the sender, 450. Next, editing the message is allowed, 460. Then, in response to the menu entry selection signal, the e-mail message is tagged and sent, 470, to implement recipient's preferences. With the sending accomplished, the process ends at 480.

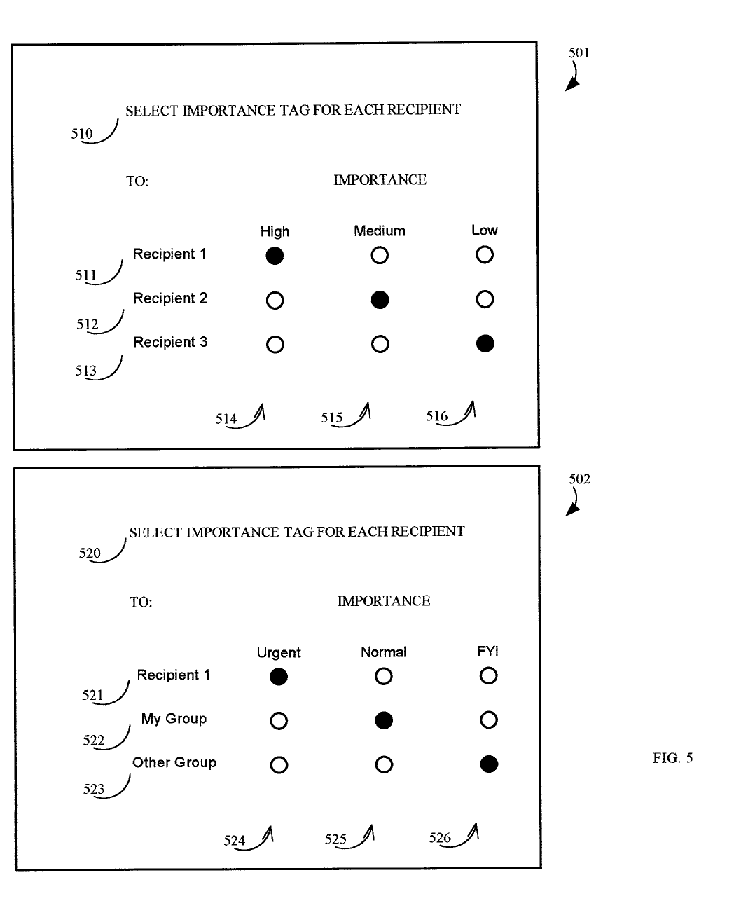

FIG. 5 is a diagram illustrating two examples, 501 and 502, of tag and recipient menus, according to the teachings of the present invention. The menus could be displayed with text and graphics, as shown at 501 and 502. An audible menu also could be provided to the sender via audio output. Spoken input also could be received from the sender via a speech recognition interface, or the sender might mark a word displayed on a screen. These examples are ways of receiving input from the sender to create a tag indicating the importance of the e-mail message for each of the recipients. These examples could be used with a method like the one shown in FIG. 3.

At the top of menu 501 is a request for input, 510. In menu 501 there are three rows, 511, 512, and 513, for three recipients. In 501 there are three columns, 514, 515, and 516, for three tags with predefined content. In this example, the tags convey information about the importance of the message: “High,” 514, “Medium,” 515, or “Low,” 516. There also could be additional columns (not shown), for example a column for entering text, allowing the sender to compose the content of the tags. A darkened circle shows input from the sender to create a tag indicating the importance of the e-mail message for each of the recipients. For example, for Recipient 1 at 511, the message tag is “High.” The tags are different for other recipients.

At the top of menu 502 is a request for input, 520. In menu 502 there are three rows, for Recipient 1, 521, My Group, 522, and Other Group, 523. In 502 there are three columns, 524, 525, and 526, for three tags with predefined content. In this example, the tags convey information about the importance of the message: “Urgent,” 524, “Normal,” 525, or “FYI,” 526. Another option is automatically providing default tags, in the absence of contrary input from the sender, wherein said default tags may vary according to the status of the recipients. For example, the tag could be “Urgent” for the primary recipient, the tag could be “Normal” for recipients who will receive a copy of the message marked “cc,” and the tag could be “FYI” for recipients who will receive a copy of the message marked “bcc.” A darkened circle shows input from the sender to create a tag indicating the importance of the e-mail message for each recipient or group. For example, for Recipient 1 at 521, the message tag is “Urgent.” The tags are different for other recipients.

FIG. 6 is a diagram illustrating two examples of tag menus to implement a recipient's preferences, according to the teachings of the present invention. The menus could be displayed with text and graphics, as shown at 601 and 602. An audible menu also could be provided to the sender via audio output. These examples could be used with a method like the one shown in FIG. 4. These examples are ways of communicating to the sender at least one of the recipient's preferences concerning e-mail received by the recipient, before an e-mail message is transmitted to the recipient. The recipient's preferences might involve the size of e-mail messages sent to the recipient, or might involve rating the importance of the e-mail message. The recipient's preferences might be implemented by receiving a menu entry selection signal from the sender. For example, the sender might mark one of the words that the recipient favors, for rating the importance of the e-mail message. Spoken input also could be received from the sender via a speech recognition interface.

At the top of menu 601 is a request for input, 610. In menu 601 there is a space for the name of a recipient, at 611, and there are three columns, 612, 613, and 614, for three tags with predefined content. The tags have content defined by Recipient 1. In this example, the tags convey information about the importance of the message, in terms that are helpful to Recipient 1: “Read today,” 612, “Within 2 days,” 613, or “Later,” 614. A darkened circle shows input from the sender to create a tag indicating the importance of the e-mail message for Recipient 1. Here, the selected message tag is “Read today,” 612.

At the top of menu 602 is a request for input, 620. In menu 602 there is a space for the name of a recipient, at 621, and there are three columns, 622, 623, and 624, for three tags with predefined content. The tags have content defined by Recipient 2. In this example, the tags convey information about the importance of the message, in terms that are helpful to Recipient 2: “Very Urgent,” 622, “Urgent,” 623, or “Normal,” 624. A darkened circle shows input from the sender to create a tag indicating the importance of the e-mail message for Recipient 2. Here, the selected message tag is “Very Urgent,” 622.

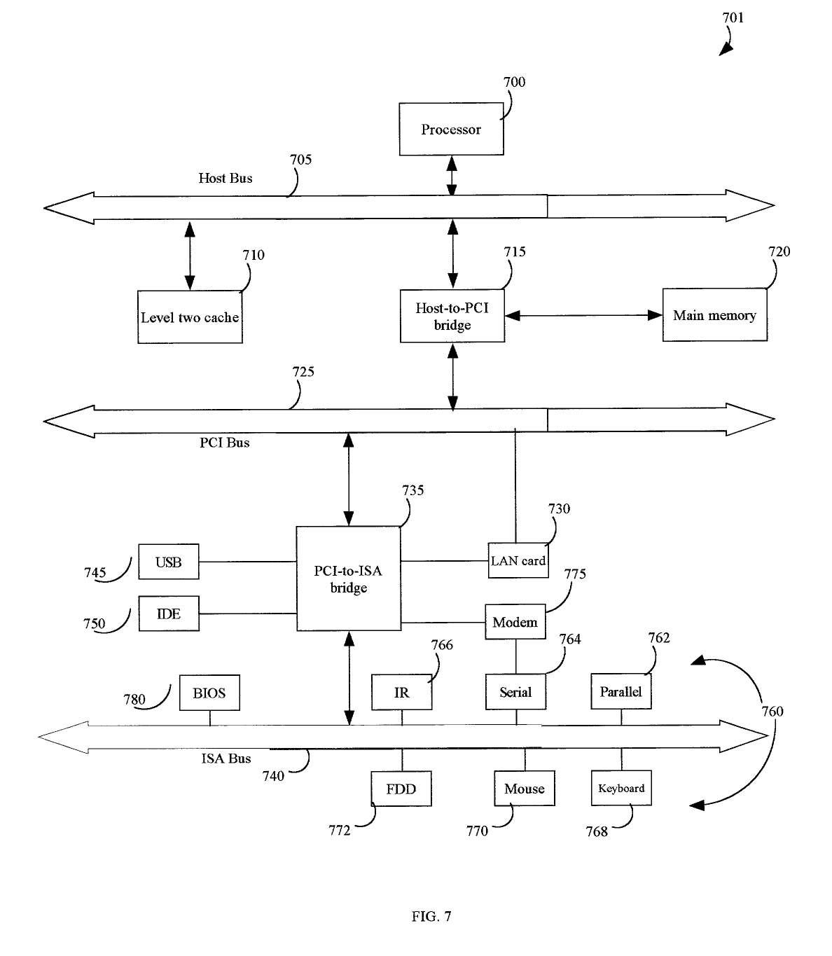

FIG. 7 illustrates information handling system 701 which is a simplified example of a computer system capable of performing the present invention. Computer system 701 includes processor 700 which is coupled to host bus 705. A level two (L2) cache memory 710 is also coupled to the host bus 705. Host-to-PCI bridge 715 is coupled to main memory 720, includes cache memory and main memory control functions, and provides bus control to handle transfers among PCI bus 725, processor 700, L2 cache 710, main memory 720, and host bus 705. PCI bus 725 provides an interface for a variety of devices including, for example, LAN card 730. PCI-to-ISA bridge 735 provides bus control to handle transfers between PCI bus 725 and ISA bus 740, universal serial bus (USB) functionality 745, IDE device functionality 750, power management functionality 755, and can include other functional elements not shown, such as a real-time clock (RTC), DMA control, interrupt support, and system management bus support. Peripheral devices and input/output (I/O) devices can be attached to various interfaces 760 e.g., parallel interface 762, serial interface 764, infrared (IR) interface 766, keyboard interface 768, mouse interface 770, and fixed disk FDD) 772 coupled to ISA bus 740. Alternatively, many I/O devices can be accommodated by a super I/O controller (not shown) attached to ISA bus 740. BIOS 780 is coupled to ISA bus 740, and incorporates the necessary processor executable code for a variety of low-level system functions and system boot functions. BIOS 780 can be stored in any computer readable medium, including magnetic storage media, optical storage media, flash memory, random access memory, read only memory, and communications media conveying signals encoding the instructions (e.g., signals from a network). In order to couple computer system 701 to another computer system over a network, LAN card 730 is coupled to PCI-to-ISA bridge 735. Similarly, to connect computer system 701 to an ISP to connect to the Internet using a telephone line connection, modem 775 is connected to serial port 764 and PCI-to-ISA Bridge 735.

While the computer system described in FIG. 7 is capable of executing the processes described herein, this computer system is simply one example of a computer system. Those skilled in the art will appreciate that many other computer system designs are capable of performing the processes described herein.

One of the preferred implementations of the invention is an application, namely a set of instructions (program code) in a code module which may, for example, be resident in the random access memory of a computer. Until required by the computer, the set of instructions may be stored in another computer memory, for example, in a hard disk drive, or in a removable memory such as an optical disk (for eventual use in a CD ROM) or floppy disk (for eventual use in a floppy disk drive), or downloaded via the Internet or other computer network. Thus, the present invention may be implemented as a computer-usable medium having computer-executable instructions for use in a computer. In addition, although the various methods described are conveniently implemented in a general-purpose computer selectively activated or reconfigured by software, one of ordinary skill in the art would also recognize that such methods may be carried out in hardware, in firmware, or in more specialized apparatus constructed to perform the required method steps. While the invention has been shown and described with reference to particular embodiments thereof, it will be understood by those skilled in the art that the foregoing and other changes in form and detail may be made therein without departing from the spirit and scope of the invention. The appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the appended claims may contain the introductory phrases “at least one” or “one or more” to introduce claim elements. However, the use of such phrases should not be construed to imply that the introduction of a claim element by indefinite articles such as “a” or “an” limits any particular claim containing such introduced claim element to inventions containing only one such element, even when the same claim includes the introductory phrases “at least one” or “one or more” and indefinite articles such as “a” or “an;” the same holds true for the use in the claims of definite articles.

I claim:

1. A method for sending electronic mail (e-mail), from a sender to a plurality of recipients, comprising:
receiving input from said sender specifying said recipients of an e-mail message; and
for each of said recipients, receiving input from said sender to create a tag indicating the importance of said e-mail message,
wherein said tags may vary from one of said recipients to another.

2. The method of claim 1, further comprising:
providing a plurality of said tags with predefined content.

3. The method of claim 2, further comprising:
automatically providing default tags, in the absence of contrary input from said sender, wherein
said default tags may vary according to the status of said recipients.

4. The method of claim 1, wherein said sender can compose the content of said tags.

5. A method for sending e-mail, from a sender to a plurality of recipients, comprising:
providing tags, to convey information about the importance of an e-mail message;
receiving input from said sender specifying said recipients of said e-mail message; and
for each of said recipients, receiving input from said sender specifying one of said tags to be placed on said e-mail message,
wherein said tags may vary from one of said recipients to another.

6. The method of claim 5, further comprising:
automatically providing default tags, in the absence of contrary input from said sender, wherein said default tags may vary according to the status of said recipients.

7. A method for providing e-mail services, said method comprising:
receiving input from a sender specifying a recipient of an e-mail message; and
communicating to said sender at least one of said recipient's preferences concerning e-mail received by said recipient, before said e-mail message is transmitted to said recipient.

8. The method of claim 7, wherein said preferences concern the size of e-mail messages sent to said recipient.

9. The method of claim 7, wherein:
said preferences concern rating the importance of said e-mail message, and,
wherein said communicating further comprises:
providing said preferences as a set of menu entries to said sender;
receiving a menu entry selection signal from said sender; and
in response to said signal, tagging said e-mail message, to implement said preferences.

10. A method for providing e-mail services, said method comprising:
maintaining a database identifying at least one e-mail recipient and his or her corresponding preferences concerning e-mail received by said recipient; and
communicating at least one of said preferences to a sender of an e-mail message, before said e-mail message is transmitted to said recipient.

11. The method of claim 10, wherein said preferences concern the size of e-mail messages sent to said recipient.

12. The method of claim 10, wherein:
said preferences concern rating the importance of said e-mail message, and;
wherein said communicating further comprises:
providing said preferences as a set of menu entries to said sender;
receiving a menu entry selection signal from said sender; and
in response to said signal, tagging said e-mail message, to implement said preferences.

13. A system for sending e-mail, from a sender to a plurality of recipients, said system comprising:
means for receiving input from said sender specifying said recipients of an e-mail message; and
for each of said recipients, means for receiving input from said sender to create a tag indicating the importance of said e-mail message,
wherein said tags may vary from one of said recipients to another.

14. The system of claim 13, further comprising:
means for providing a plurality of said tags with predefined content.

15. The system of claim 14, further comprising:
means for automatically providing default tags, in the absence of contrary input from said sender,
wherein said default tags may vary according to the status of said recipients.

16. The system of claim 13, wherein said sender can compose the content of said tags.

17. A system for providing e-mail services, said system comprising:
means for maintaining a database identifying at least one e-mail recipient and his or her corresponding preferences concerning e-mail received by said recipient; and
means for communicating at least one of said preferences to a sender of an e-mail message, before said e-mail message is transmitted to said recipient.

18. The system of claim 17, wherein said preferences concern the size of e-mail messages sent to said recipient.

19. The system of claim 17, wherein:
said preferences concern rating the importance of said e-mail message, and;
wherein said means for communicating further comprises:
means for providing said preferences as a set of menu entries to said sender;
means for receiving a menu entry selection signal from said sender; and
means for tagging said e-mail message, in response to said signal, to implement said preferences.

20. A computer-usable medium having computer-executable instructions for sending e-mail, from a sender to a plurality of recipients, said computer-executable instructions comprising:
means for receiving input from said sender specifying said recipients of an e-mail message; and
for each of said recipients, means for receiving input from said sender to create a tag indicating the importance of said e-mail message,
wherein said tags may vary from one of said recipients to another.

21. The computer-usable medium of claim 20, further comprising:
means for providing a plurality of said tags with predefined content.

22. The computer-usable medium of claim 21, further comprising:
means for automatically providing default tags, in the absence of contrary input from said sender,
wherein said default tags may vary according to the status of said recipients.

23. The computer-usable medium of claim 20, wherein said sender can compose the content of said tags.

24. A computer-usable medium having computer-executable instructions, comprising:
means for maintaining a database identifying at least one e-mail recipient and his or her corresponding preferences concerning e-mail received by said recipient; and
means for communicating at least one of said preferences to a sender of an e-mail message, before said e-mail message is transmitted to said recipient.

25. The computer-usable medium of claim 24, wherein said preferences concern the size of e-mail messages sent to said recipient.

26. The computer-usable medium of claim 24, wherein:
said preferences concern rating the importance of said e-mail message, and;
wherein said means for communicating further comprises:
means for providing said preferences as a set of menu entries to said sender;
means for receiving a menu entry selection signal from said sender; and
means for tagging said e-mail message, in response to said signal, to implement said preferences.
